(19) United States
(12) Patent Application Publication
(10) Pub. No.: US 2005/0234796 A1
(43) Pub. Date: Oct. 20, 2005

(54) Minimum relative performance method for allocating assets among one or more third-party investment managers

(76) Inventor: Arthur Lipper III, Del Mar, CA (US)

Correspondence Address: Royal W. Craig;Law Offices of Royal W. Craig, Suite 153, 10 N. Calvert Street, Baltimore, MD, 21202, US

(21) Appl. No.: 11/105,003

(22) Filed: Apr. 13, 2005

Related U.S. Application Data
(60) Provisional application No. 60/562,021, filed on Apr. 14, 2004.

(51) Int. Cl. G06F 17/60

(52) U.S. Cl. 705/36

(57) ABSTRACT

A financial portfolio management method for asset allocation of pension and other institutional funds that reflects and accommodates the needs of fund administrators while simultaneously benefitting those independent investment managers that succeed in meeting agreed upon minimum relative performance objectives. The method of the present invention includes the execution of an agreement, specifying certain performance objectives, between a fund's administrators and an independent investment manager. The independent investment manager is provided with the opportunity to receive an overall management fee that is significantly greater than that provided by traditional, annual fee structures and for greater periods of time than has been the norm, in return for the assumed contractual risk. The payment of the management fees is a two-stage process. The first stage involves annual fee payments corresponding to a traditional fee structure, with the balance being held in escrow until the end of the specified contractual period. The second stage involves the lump-sum payment of the escrow amount, or some portion thereof, once the agreed upon period of time has expired.

### CROSS-REFERENCE TO RELATED APPLICATIONS

The present application derives priority from U.S. Provisional Application No. 60/562,021 filed Apr. 14, 2004.

### BACKGROUND OF THE INVENTION

1. Field of the Invention

The present invention relates to financial portfolio management and, more particularly, to a method for obtaining a guaranteed minimum relative return on investment (RROI) over a given period of time and, even more particularly, to a method for allocating a portfolio's assets among one or more third-party investment managers who are contractually bound to deliver a specified minimum relative ROI during the term of the contract.

2. Description of the Background

Fiduciaries, especially those making decisions on behalf of others with respect to investments, are required to balance the need for an adequate and predictable ROI against the level of associated risk deemed acceptable in terms of available alternative investments. In the area of pension funds and other large pools of capital, an investment manager seeks to generate sufficient investment returns to at least meet the amount of predictable withdrawals from the fund. It is well-known that equity investments, as measured by unmanaged averages and indices, have over longer periods historically produced a superior ROI as compared to fixed income debt portfolios and, therefore, there has been a trend toward increased use of equities in asset allocation. While contributors to investment funds may be willing to accept a degree of risk commensurate with changes experienced by the stock market in general, as measured by relevant unmanaged market averages and indices, they typically expect a ROI at least as good as those unmanaged stock market averages/indices.

In response, some fiduciaries have elected to use an index fund approach by arranging investment portfolios to mirror the composition of the indices being used as market measures. Unfortunately, the frictional costs and other factors affecting the performance of those index funds are such that, in most cases, the goal of equivalent performance is not achieved.

Some pension funds and managers of large pools of capital have elected to manage their investment portfolios internally (i.e. using employees of the fund or its sponsor), whereas others have selected and contracted with independent, external (i.e. third-party) investment managers. Some funds even use a combination of internal and external investment managers. The costs associated with managing the assets of a fund are of prime importance to an investment manager because those costs are considered to be controllable, whereas market performance is subject to many factors and is generally considered to be unpredictable. Therefore, the economic leverage of large pension funds, which are based on the amount of available assets, have been used to establish limits on the fees paid to those independent investment managers seeking to manage a segment of the fund.

The annual management fee paid by a pension fund to an independent (i.e. third-party) investment manager is usually a fraction of one percent. In the case of an indexed fund, the fee may be less than twenty (10) basis points (bps), or one-tenth of one percent. Nonetheless, there is a high level of competition amongst independent investment managers for pension fund asset allocations because, once a manager has a reasonable amount of assets subject to their management, the manager does not incur significant incremental costs when additional assets are added to the assets under management.

An independent investment manager is typically selected by a fund based on one or more of the following criteria; reputation for integrity, historic investment management performance, political considerations, specialty of investment focus, or effectiveness of marketing by the investment management organization. Unfortunately, despite the best efforts of a fund's administrators, the investment performance of an independent manager, in many instances, does not meet the expectations (i.e. a specific minimum ROI over a given period of time) of those individuals responsible for making the decisions associated with asset allocation.

To the best of the knowledge of the present inventor, no method for providing fund administrators with a guaranteed minimum relative RROI over a specified period of time exists. Therefore, there remains a need for a financial portfolio management method that enables fiduciaries, or administrators, to achieve their underlying responsibilities for preserving a fund's principal, while obtaining the higher, targeted returns historically associated with equity investment performance over a multi-year, investment period. Of course, funds and other pools of capital using debt and other investing instruments have the same need to assure a minimum relative return on investment. A method of this type should shift a portion of the investment risk from the fiduciaries to the third-party investment manager(s) in return for the possibility of obtaining significantly increased portfolio management fees. The method should also be, in addition to that outlined above, inexpensive to implement, fair and simple to apply.

### SUMMARY OF THE INVENTION

It is, therefore, a primary object of the present invention to provide an improved financial portfolio management method that is inexpensive to implement, accommodates the needs of fund administrators, and simultaneously rewards successful independent investment managers.

It is another object of the present invention to provide an improved financial portfolio management method that rewards independent investment managers for successfully achieving agreed upon minimum relative performance objectives, thereby increasing the pool of qualified candidates that may be considered by a fund's administrators.

A further object of the present invention is to provide an improved financial portfolio management method that includes an agreement between a fund's administrators and an independent investment manager obligating the latter to: 1) a defined market performance measure; 2) a minimum acceptable level of investment performance; and 3) a specified multi-year period. In return the independent investment manager will be paid an annual management fee that is significantly greater than traditional fee structures. Another object of the present invention is to provide an improved financial portfolio management method that provides for the payment of management fees according to a two-stage escrow process.

These and other objectives are accomplished by a financial portfolio management method for asset allocation of pension and other institutional funds, that reflects and accommodates the needs of fund administrators while simultaneously benefitting those independent investment managers that succeed in meeting agreed upon minimum relative performance objectives. The method of the present invention generally includes the step of executing an agreement between a fund's administrators and an independent investment manager defining: 1) a specific market performance measure; 2) a minimum acceptable level of relative ROI performance; and 3) a specified multi-year period. In return for the contractual risk assumed by the independent investment manager (in the form of guaranteeing the minimum relative ROI performance including investment management fees), that manager is provided with the opportunity to receive an overall management fee that is significantly greater than that provided by traditional, annual fee structures not requiring an agreed minimum level of relative investment performance.

However, to provide the fund's administrators with an appropriate degree of assurance as to the independent investment manager's ability to meet the obligations defined in the agreement, the payment of management fees according to the method of the present invention is a two-stage process. The first stage involves annual fee payments corresponding to a traditional fee structure, with the balance (i.e. the differential between the management fee defined in the agreement and a traditional fee structure) being held in escrow until the end of the specified multi-year period. The second stage involves the lump-sum payment of the escrow amount, or some portion thereof, once the agreed upon multi-year period has expired.

As an alternate (or additional) assurance of the independent investment manager's ability to meet the obligations defined in the agreement, the method of the present invention may employ the endorsement by a third-party underwriter of all, or a portion, of the manager's financial risk, as determined by the fund's administrators.

The method of the present invention provides a pension/institutional fund's administrators with a predictable multi-year, relative, ROI, inclusive of all management fees, that satisfies the fund's minimum goals and requirements. The method is inexpensive to implement for those funds already using external investment managers because it only incrementally adds (i.e. execution of the aforementioned agreement) to what is typically an existing process for soliciting third-party investment managers. Utilization of the present invention also increases the number of independent investment managers that may be considered by a fund's administrators.

Independent investment managers also benefit from the method of the present invention because it allows them to increase the total amount of assets under their management, thereby providing the opportunity to increase overall profitability through certain economies of scale, and to receive far greater management fees for simply achieving an agreed to minimum relative performance.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a flow chart of an improved financial portfolio management method 100 according to a preferred embodiment of the present invention.

### DETAILED DESCRIPTION OF THE PREFERRED EMBODIMENTS

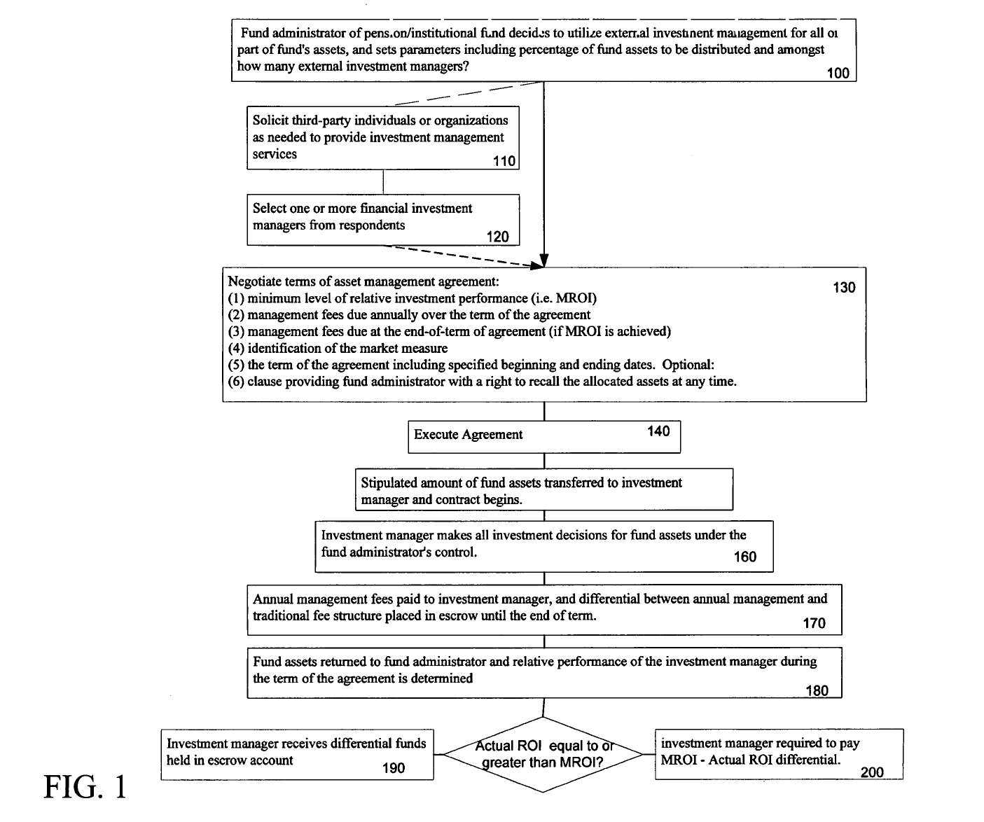

FIG. 1 is a flow chart of the preferred embodiment of the financial portfolio management method of the present invention. The method reflects and accommodates the needs of fund administrators while simultaneously benefitting those independent investment managers that succeed in meeting agreed upon minimum relative performance objectives.

With reference to the flow chart, the method generally begins at step 100 with the fund administrator of a pension/institutional fund deciding to utilize external investment managers for all or part of the fund's assets, and establishing parameters including percentage of the fund's total assets to be distributed and among how many of the external investment managers?

At step 110 the fund administrator may optionally soliciting third-party individuals or organizations as needed to provide management services of that kind. Of course, the solicitation is optional because the present method may be readily implemented with an existing investment manager already in place. For these latter funds that already use external investment managers, the method is very inexpensive to implement as it only incrementally adds to the existing process by the negotiation and execution of an agreement as per steps 130 and 140 described below.

The solicitation process of step 110 may take the form of competitive bidding wherein the independent investment managers submit proposals that guarantee the fund's administrators a minimum level of ROI performance, relative to a stipulated market measure and inclusive of all management fees, over a specified period of time (e.g. ROI equal or greater to the Dow Jones Industrial Average, S&P 500 or a customized average of large mutual funds for a “two percent of average assets” annual management fee over a period of five years).

Inasmuch as the present method is one of “guaranteed minimum relative return”, and is not an index, the expectation of the administrators of the pension/institutional fund allocating the assets is, naturally, the minimum specified in the agreement. Therefore, it is possible that slightly sub-par guaranteed relative performance bids may be acceptable in certain circumstances.

At step 120, depending on the parameters established by the fund's administrators (e.g. what percentage of the fund's total assets is to be distributed among how many external investment managers), one or more financial investment managers are selected from all of the respondents.

Each of the independent investment managers selected at step 120 proceed to step 130 where, typically on an individual basis, the terms of an asset management agreement are negotiated. The parameters of an asset management agreement, in accordance with the present invention, typically include (1) a minimum level of relative investment performance (“MROI”), (2) management fees due annually over the term of the agreement, (3) management fees due at the end of the term of the agreement if the minimum MROI is achieved, (4) identification of the market measure, and (5) the term of the agreement including specified beginning and ending dates. The agreement may also include a clause providing the fund's administrators with the right to recall the allocated assets at any time.

The minimum level of relative investment performance MROI and the various management fees may be any value acceptable to the fund's administrators and the investment manager. The market measure may be an unmanaged index or average, such as the S&P 500 or the Dow Jones Industrial Average, or alternatively a customized market measure comprising selected mutual funds or other investment vehicles. A typical term for the agreement is five years, however, it may be any time period acceptable to the fund's administrators and the investment manager.

At step 140, the asset management agreement negotiated at step 130 is executed by the fund's administrators and the independent investment manager. In return for the contractual risk assumed, in the form of the minimum relative ROI performance, the independent investment manager is provided with the opportunity to receive an overall management fee that is significantly greater than that provided by traditional fee structures e.g. (a fee equal to 200 basis points as compared with twenty basis points).

Once the agreement is in place, the stipulated amount of pension/institutional assets, at step 150, are transferred to the investment manager and the contractually specified time period begins.

Step 160 indicates that, during the specified time period, the investment manager is responsible for making all of the investment decisions associated with the fund assets under the administrator's control.

The method of the present invention provides the fund's administrators with an appropriate degree of assurance as to the independent investment manager's ability to meet the obligations defined in the agreement by structuring the payment of the management fees as a two-stage process.

The first stage, step 170, involves annual fee payments corresponding to a traditional fee structure, with the balance (i.e. the differential between the management fee defined in the agreement and a traditional fee structure) being held in escrow until the end of the specified multi-year period (see discussion of step 190 below).

At step 180, when the contractually specified time period ends, all of the fund assets are returned to the control of the administrators and the overall relative performance of the investment manager during the term of the agreement is determined. The analysis of overall performance is very straightforward—the differential between the management fee defined in the agreement and a traditional fee structure) being held in escrow until the end of the specified multi-year period (see discussion of step 190 below).

If the actual ROI is equal to or greater than the MROI as specified in the agreement, the investment manager receives, at step 190, the second stage, or lump sum, management fee payment that had been held in an escrow account. The amount of this payment is typically the total management fee amount specified in the agreement less the total of the annual management fees paid, in accordance with step 170, throughout the term of the agreement.

If at step 200 the actual ROI is less than the MROI as specified in the agreement, the investment manager will be required to pay to the fund administrator a relative performance differential as a penalty. The relative performance penalty is proportionate to the difference of the ROI performance less the negotiated MROI, and is most preferably equal to the amount that the investment manager would have been paid from escrow had actual ROI exceeded MROI. Therefore, the investment manger would not receive any of the monies being held in escrow as they would not have been earned as the terms of the contract had not been fulfilled.

As an alternate (or additional) assurance of the independent investment manager's ability to meet the obligations defined in the agreement, the method of the present invention may employ the endorsement by a third-party underwriter of all, or a portion, of the manager's financial risk, as determined by the fund's administrators.

The financial portfolio management method of the present invention reflects and accommodates the needs of fund administrators, as well as the beneficiaries of the fund, while simultaneously benefitting those independent investment managers that succeed in meeting agreed upon minimum relative performance objectives. The method of the present invention provides a pension/institutional fund's administrators with a predictable multi-year relative ROI, inclusive of all management fees, that may be structured to satisfy the fund's minimum relative goals and requirements. The method is inexpensive to implement for those funds already using external investment managers because it only incrementally adds (i.e. execution of the aforementioned agreement) to what is typically an existing process for soliciting third-party investment managers. Utilization of the present invention also increases the number of independent investment managers that may be considered by a fund's administrators.

Independent investment managers also benefit from the method of the present invention because it allows them to increase the total amount of assets under their management, thereby providing the opportunity to increase overall profitability through certain economies of scale, and to receive far greater management fees for simply achieving an agreed to minimum relative performance. The method 100 may also provide investment management firms with a reduced need for expensive marketing efforts with regard to key, prospective accounts that may have been difficult to access previously. Additionally, use of the present invention may assist in establishing a performance showcase that assists in obtaining further asset allocations on conventional terms.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

1. A financial portfolio management method for fund administrators, comprising the steps of:
soliciting third-party portfolio management participation from a plurality of third-party investment managers;
selecting one or more of said solicited third-party investment managers to participate;
negotiating an asset allocation agreement with each of said selected one or more third-party investment managers, said agreement including contractual terms inclusive of an effective term of said agreement, a management fee, and a minimum relative investment performance (“MROI”);
executing said asset allocation agreement with each of said selected one or more third-party investment managers;
transferring fund assets to each of said selected one or more third-party investment managers;
paying a portion of said negotiated management fee to each of said selected one or more third-party investment managers on an annual basis;
at the end of said effective term, calculating a difference between an actual ROI performance of each of said selected one or more third-party investment managers and said MROI, and for each of said selected one or more third-party investment managers with actual ROI performance equal or exceeding said negotiated MROI, paying the remainder of said negotiated management fee to each of said selected one or more third-party investment managers.

2. The method of claim 1, wherein said step of paying a portion of said negotiated management fee to each of said selected one or more third-party investment managers on an annual basis further comprises placing a remaining amount of said negotiated management fee into an escrow account pending expiration of the negotiated term.

3. The method of claim 1, wherein said step of calculating a difference further comprises, for each of said selected one or more third-party investment managers with actual ROI performance less than said negotiated MROI, charging a penalty.

4. The method of claim 3, wherein said penalty is proportionate to the difference of the ROI performance less than said negotiated MROI.

5. The method of claim 4, wherein said penalty is equal to the amount that the investment manager would have been paid from escrow had actual ROI exceeded MROI.

6. A financial portfolio management method for fund administrators, comprising the steps of:
negotiating an asset allocation agreement with an investment manager, said agreement including contractual terms inclusive of an effective term of said agreement, a management fee, and a minimum relative investment performance (“MROI”);
executing said asset allocation agreement with said investment manager;
transferring fund assets to said investment manager;
paying a portion of said negotiated management fee to said investment manager on an annual basis;
at the end of said effective term, calculating a difference between an actual ROI performance of said investment manager and said MROI, and if an actual ROI performance equals or exceeds said negotiated MROI, paying the remainder of said negotiated management fee to said investment manager.

7. The method of claim 6, wherein said step of paying a portion of said negotiated management fee to said investment manager on an annual basis further comprises placing a remaining amount of said negotiated management fee into an escrow account pending expiration of the negotiated term.

8. The method of claim 7, wherein said step of calculating a difference further comprises charging a penalty if actual ROI performance is less than said negotiated MROI.

9. The method of claim 8, wherein said penalty is proportionate to the difference of the ROI performance less than said negotiated MROI.

10. The method of claim 9, wherein said penalty is equal to the amount that the investment manager would have been paid from escrow had actual ROI exceeded MROI.
